(19) United States
(12) Patent Application Publication
(10) Pub. No.: US 2016/0105808 A1
(43) Pub. Date: Apr. 14, 2016

(54) IN-DEVICE INTERFERENCE MITIGATION FOR SIMULTANEOUS CALLS

(71) Applicant: QUALCOMM Incorporated, San Diego, CA (US)

(72) Inventors: Wei-Jei SONG, San Diego, CA (US); Tom CHIN, San Diego, CA (US)

(21) Appl. No.: 14/511,851

(22) Filed: Oct. 10, 2014

(51) Int. Cl. H04W 24/02; H04W 52/38

(52) U.S. Cl. CPC H04W 24/02; H04W 52/38; H04W 88/06

(57) ABSTRACT

A user equipment (UE) mitigates in-device interference caused by a simultaneous circuit-switched call on a first subscriber identity module (SIM) and another call on a second subscriber identity module (SIM) at the UE. The UE detects in-device interference between the circuit switched call and the other call. The UE then suspends the other call or reduces a transmit power of the other call when the in-device interference is above a predetermined threshold. The UE resumes the other call or increases the transmit power of the other call when the circuit switched call ends.

### BACKGROUND

1. Field

Aspects of the present disclosure relate generally to wireless communication systems, and more particularly, to reducing in-device interference by monitoring and coordinating simultaneous circuit-switched and packet-switched calls of a multi subscriber identity module (SIM) multi active device.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes detecting in-device interference between a first circuit switched call and another call in a multi subscriber identity module, multi active device. The method also includes suspending the other call or reducing a transmit power of the other call when the in-device interference is above a predetermined threshold. The method includes resuming the other call or increasing the transmit power of the other call when the first circuit switched call ends.

According to another aspect of the present disclosure, an apparatus for wireless communication includes means for detecting in-device interference between a first circuit switched call and another call in a multi subscriber identity module, multi active device. The apparatus may also include means for suspending the other call or reducing a transmit power of the other call when the in-device interference is above a predetermined threshold. The apparatus may also include means for resuming the other call or increasing the transmit power of the other call when the first circuit switched call ends.

Another aspect discloses a computer program product having a non-transitory computer-readable medium for wireless communications in a wireless network. The computer readable medium has non-transitory program code recorded thereon which, when executed by the processor(s), causes the processor(s) to perform the operation of detecting in-device interference between a first circuit switched call and another call in a multi subscriber identity module, multi active device. The program code also causes the processor(s) to suspend the other call or reduce a transmit power of the other call when the in-device interference is above a predetermined threshold. The program code also causes the processor(s) to resume the other call or increase the transmit power of the other call when the first circuit switched call ends.

Another aspect discloses an apparatus for wireless communication and includes a memory and at least one processor coupled to the memory. The processor(s) is configured to detect in-device interference between a first circuit switched call and another call in a multi subscriber identity module, multi active device. The processor(s) is also configured to suspend the other call or reduce a transmit power of the other call when the in-device interference is above a predetermined threshold. The processor(s) is further configured to resume the other call or increase the transmit power of the other call when the first circuit switched call ends.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a flow diagram illustrating a method for wireless communication according to one aspect of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

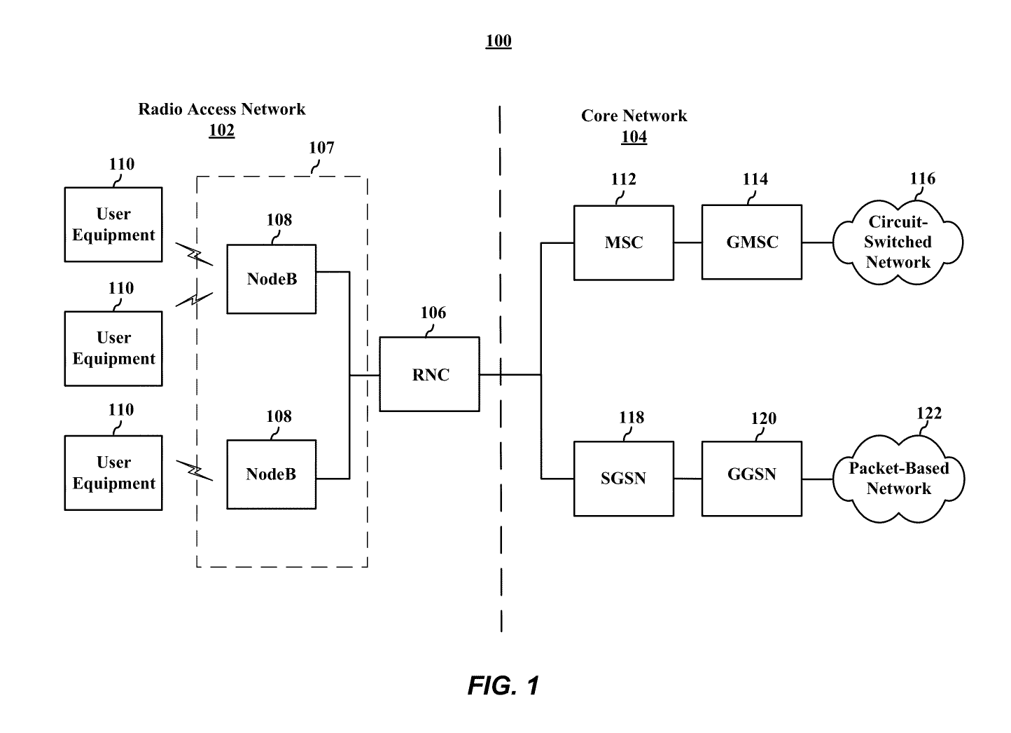

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

General packet radio service (GPRS) is designed to provide packet-data services at speeds higher than those available with standard GSM circuit switched data services. The core network 104 also supports packet-data services with a serving GPRS support node (SGSN) 118 and a gateway GPRS support node (GGSN) 120. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

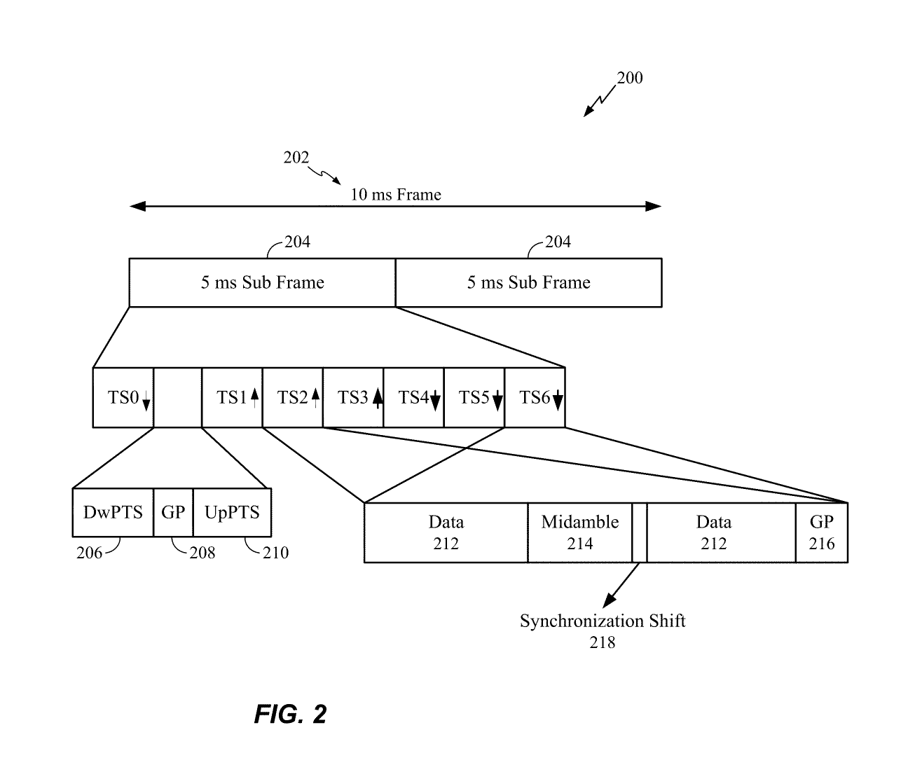

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization Shift bits 218 only appear in the second part of the data portion. The synchronization shift bits 218 immediately following the midamble can indicate three cases: decrease shift, increase shift, or do nothing in the upload transmit timing The positions of the synchronization shift bits 218 are not generally used during uplink communications.

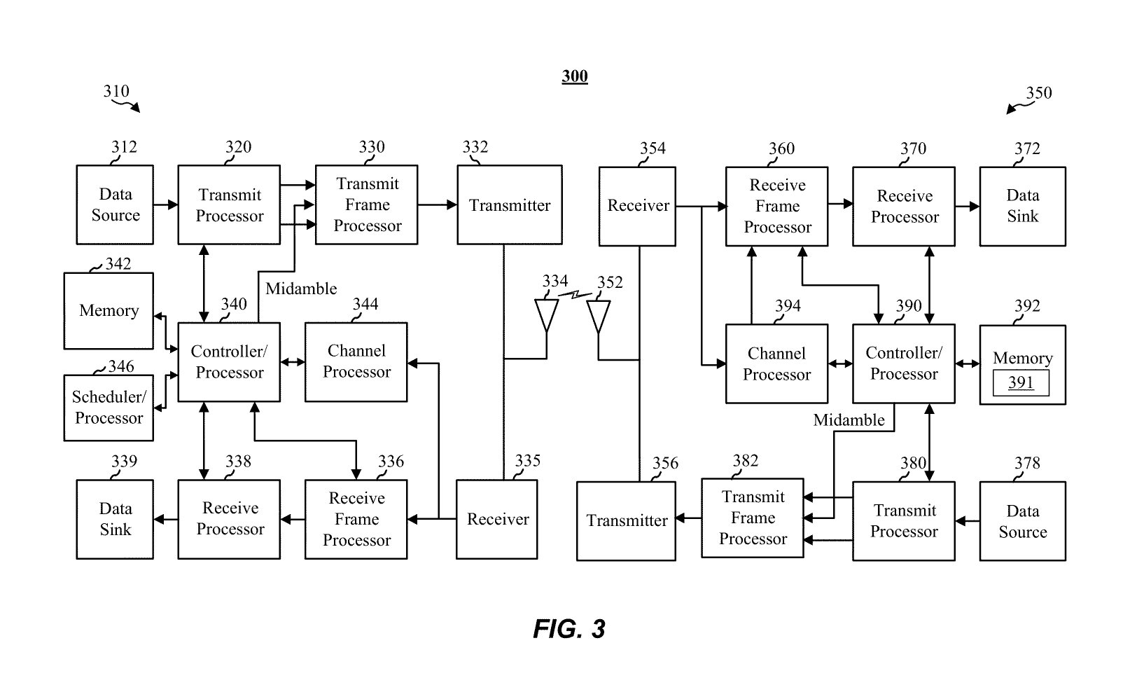

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B310 and the UE 350, respectively. For example, the memory 392 of the UE 350 may store an interference mitigation module 391 which, when executed by the controller/processor 390, configures the UE 350 for cell reselection. A scheduler/processor 346 at the node B310 may be used to allocate resources to the UEs and schedule downlink and/or uplink transmissions for the UEs.

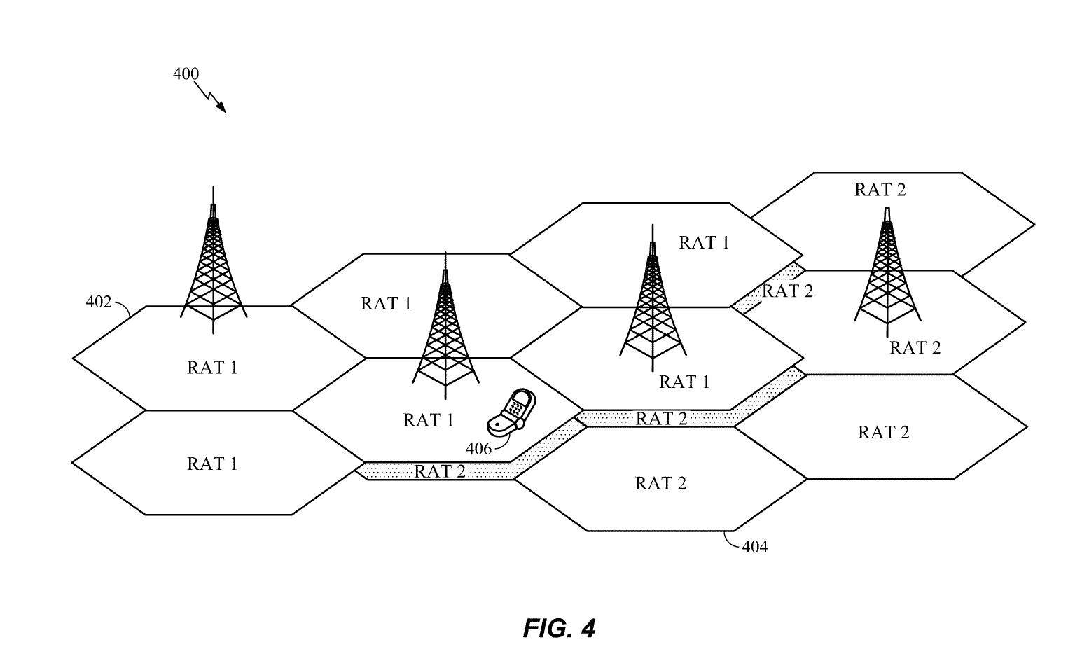

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as GSM, TD-SCDMA or Long Term Evolution (LTE) and also illustrates a newly deployed network utilizing a second type of radio access technology (RAT-2), such as a GSM, TD-SCDMA or Long Term Evolution (LTE). Those skilled in the art will appreciate that the network may contain more than two types of RATs. For example, the geographical area 400 may also include a third RAT, such as, but not limited to GSM, TD-SCDMA or Long Term Evolution (LTE).

The geographical area 400 may include RAT-1 cells 402 and RAT-2 cells 404. In one example, the RAT-1 cells are TD-SCDMA/GSM cells and the RAT-2 cells are LTE cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

A user equipment (UE) may include more than one subscriber identity module (SIM) or universal subscriber identity module (USIM). A UE with more than one SIM may be referred to as a multi-SIM device. In the present disclosure, a SIM may refer to a SIM or a USIM. Each SIM may also include a unique International Mobile Subscriber Identity (IMSI) and service subscription information. Each SIM may be configured to operate in a particular radio access technology. Each SIM may be associated with a same or different service provider or operator. Moreover, each SIM may have full phone features and be associated with a unique phone number. Therefore, the UE may use each SIM to send and receive phone calls. That is, the UE may simultaneously communicate via the phone numbers associated with each individual SIM. For example, a first SIM card can be associated for use in a City A and a second SIM card may be associated for use in a different City B to reduce roaming fees and long distance calling fees. Alternately, a first SIM card may be assigned for personal usage and a different SIM card may be assigned for work/business purposes. In another configuration, a first SIM card provides full phone features and a different SIM card is utilized mostly for data services.

Many multi-SIM devices support multi-SIM multi-standby operation using a single radio frequency (RF) chain to transmit and receive communications. The multi-SIM device may include a first SIM dedicated to operate in first RAT and a second SIM dedicated to operate in a second RAT. In one illustrative example, the multi-SIM device includes a first SIM configured to operate in GSM (i.e., G subscription) and a second SIM configured to operate in TD-SCDMA (i.e., T subscription). The multi-SIM device may operate in other RATS known to those skilled in the art.

The multi-SIM multi-standby device (e.g., UE) may be a dual SIM-dual standby (DSDS), which means the UE is limited to connecting to one network at a time. Alternatively, a UE may be dual-SIM-dual active (DSDA), which means the UE may connect to multiple networks simultaneously. For example, the DSDA UE is capable of simultaneous circuit switched and packet switched calls. When there is a DSDA configuration, the application for network mapping may be accomplished concurrently. A UE may also be configured with more than two SIMs where the more than two SIMs are active at the same time, for example, triple-SIM-triple active (TSTA), etc. The teachings of this disclosure may apply for a variety of configurations of multiple SIMs and corresponding activity.

A UE may include a number of RATs to support communication with different wireless networks. For example, the radio technologies may include a wide area network (e.g., third generation partnership project (3GPP) long-term evolution (LTE) or 1× radio transmission technology (1×)), wireless local area network (WLAN), Bluetooth, and/or the like. The multi SIM configuration allows for mapping to multiple operators and RATs for launching a single application. The application may be a voice application, a data application or both. The voice application may be a circuit switched call such as real-time voice and the data application may be a packet switched call such as best-effort traffic. The DSDA configuration provides concurrent network access where the connectivity engine may route a first application to the first operator and the second application to a second network operator.

Multi-SIM multi active device (e.g., DSDA UE) design implementation presents significant radio frequency challenges due to two radios being simultaneously active at a same time. A UE may experience in-device interference problems that result from simultaneous communication between different radio access technologies of the multi-SIM device. For example, certain communications (e.g., circuit or packet switched call transmissions) from a first RAT may cause interference or de-sense communications (circuit switched call receptions) of a same or different RAT. De-sensing is the degradation in sensitivity of a communication due to noise sources. The noise sources may be generated by a different communication in the same multi-SIM device. For example, transmission of a first subframe of a RAT may cause reception of a second subframe of a same or different RAT to be de-sensed.

To account for the degraded reception of communications caused by de-sensing, the communication may be retransmitted. Multiple retransmissions may cause the UE to heat up and drain the UE battery power. The retransmissions may also cause waste of communication resources allocated to the UE. For example, the retransmissions may cause futile and excessive usage of data bandwidth when the de-sense condition is not ideal during simultaneous circuit switched and packet switched calls. Air traffic resources are wasted on the retransmissions, which causes unrealized air traffic charges or futile results of a pre-paid charged card.

Some multi-SIM devices include a filter (e.g., hardware filter) to mitigate the effect of de-sensing. However, the hardware solution may not be feasible when two radio frequencies are close. In addition, some multi-SIM devices may not include the hardware filter because of additional costs associated with the hardware filter. In addition, some operators may include call waiting features at the network. However, the simultaneous calls may be from different networks such that a first network may not be aware of a call on a second network.

### In-Device Interference Mitigation of Simultaneous Circuit Switched and Packed Switched Calls

Aspects of the present disclosure are directed to an implementation for mitigating in-device interference caused by simultaneous circuit-switched and packet-switched calls at a user equipment (e.g., a multi subscriber identity module (SIM) multi active device). The implementation may be a software implementation or may be implemented in conjunction with a hardware implementation (e.g., a hardware filter.) The user equipment (UE) monitors performance of the simultaneous circuit-switched and packet-switched calls and coordinates communication of the simultaneous circuit-switched and packet-switched calls.

In one aspect of the disclosure, the UE detects in-device interference between the circuit switched call and another call. The circuit switched call may be associated with a first subscriber identity module while the other call is associated with a second subscriber identity module. For example, the other call may be from a first radio access technology (e.g., TD-SCDMA, LTE) on the first subscriber identity module and may cause interference or de-sense the circuit switched call of a same or different RAT (e.g., GSM or TD-SCDMA) on the second subscriber identity module. When the in-device interference is above a predetermined threshold, the user equipment suspends the other call or reduces a transmission power of the other call (e.g., backing off the transmission power). The UE then resumes the other call or increases the transmission power of the other call when the circuit switched call ends.

In one aspect of the disclosure, the other call is a circuit switched call. For example, the UE may simultaneously maintain up to two active circuit switched calls on different subscriber identity modules according to the software implementation. As noted, the UE detects in-device interference between a first circuit switched call on the first subscriber identity module and a second circuit switched call on the second subscriber identity module.

When the in-device interference is above a threshold, the UE suspends or reduces a transmission power of one of the circuit switched calls in favor of the other circuit switched call. For example, the UE reduces the transmission power of the second circuit switched call when the second circuit switched call de-senses or causes interference to the first circuit switched call. The reduction in transmission power of the second circuit switched call is such that the voice quality of the second circuit switched call is maintained at a desirable level.

In one aspect of the disclosure, the UE suspends the second circuit switched call or reduces the transmission power of the second circuit switched call during periods corresponding to a silent period of the voice communication (e.g., when the user is not transmitting). Moreover, the likelihood of de-sensing a circuit switched call is low (e.g., thirteen collision per sixty seconds) because of the relatively small number of time slots for sustaining a voice call. For example, the LIE transmits silence insertion descriptor frames periodically in the absence of voice or signaling associated with the second circuit switched call. The transmit frequency of the silence insertion descriptor are reduced (several Hz from 50 Hz) relative to the transmit frequency of the voice or signal communicated. The UE is therefore able to receive circuit switched communication from the first RAT during such periods in which normal circuit-switched voice or silence insertion descriptor frames of the second SIM are not transmitted. Furthermore, the de-sense effect of a circuit switched call is much more manageable than a data call because the transmission power of a circuit switched call (e.g.,-9 dBm) is much less than the transmission power of a packet switched call (e.g., 23 dBm).

In one aspect of the disclosure, the other call is a packet switched call. For example, the UE may simultaneously maintain an active circuit switched call (e.g., GSM) on the first subscriber identity module and an active packet switched call (e.g., TD-SCDMA) on a second subscriber identity module according to the software implementation. The packet switched call (e.g., large data file download) may be suspended or subjected to reduced transmission power when the in-device interference exceeds a threshold. The level of the in-device interference may depend on frequency and band assignments as well as the transmit power, date rate of the circuit switched call and/or the packet switched call. The level of the in-device interference may also be dependent or independent on the modulation scheme (e.g., 16 quadrature amplitude modulation) applied to the simultaneous calls or the number of slots for communication.

In one aspect of the disclosure, the UE suspends the packet switched call when the packet switched call de-senses or causes interference to the circuit switched call. Because packet switched calls are generally not delay sensitive, the packet switched call may be suspended causing little or no disruptions to the packet switched communication.

In one aspect of the present disclosure, the UE monitors a frequency setting/assignment for the circuit switched and the packet switched calls and determines whether to temporarily suspend the packet switched call. The UE may suspend the packet switched call when a large number of cyclic redundancy check (CRC) errors are indicated or when a strong conflict or interference is expected from de-sense patterns. For example, for a higher priority circuit switched call a higher degree of communication degradation due to the de-sense effect is expected when the packet switched call continues. Further, the UE may suspend the packet switched call when uplink closed loop power control (CLPC) is at a maximum transmit power level (MTPL), even though the path loss is not that high for a packet switched call and a large percentage of retransmits are detected. This combination of the uplink CLPC being at a maximum transmit power level (MTPL), low path loss, and high re-transmission indicates that the transmit suspension (or transmit blanking) is interfering with the uplink channels for the packet switched call (e.g., data call). As a result, suspending the data call is desirable. The packet switched call is resumed or the transmission power for the packet switched call is increased when the circuit switched call is completed.

In one aspect of the present disclosure, detecting the in-device interference between a circuit switched call and another call in the UE is based on the throughput of the other call. For example, when the other call is a packet switched call, the detecting is based on the throughput of the packet switched call where the throughput degradation ranges from thirty percent to about ninety eight percent.

In one aspect of the disclosure, detecting the in-device interference between a circuit switched call and another call in the UE is based on downlink error rate. For example, when the downlink error rate of the circuit switched call is increased, indicating a degradation in the voice call, the UE may detect the in-device interference in accordance with the software implementation.

In one aspect of the disclosure, detecting the in-device interference between a circuit switched call and another call in the UE is based on uplink mobile transmission power. For example, the detecting may be initiated when the uplink mobile transmission power of the other call has exceeded a threshold value over a specified time period.

In one aspect of the disclosure, detecting the in-device interference between a circuit switched call and another call in the UE is based on an expected de-sense pattern. For example, the detecting may be initiated when a strong conflict or interference is expected based on the de-sense patterns.

In one aspect of the disclosure, detecting the in-device interference between a circuit switched call and another call in the UE and/or suspending the other call is based on whether a hardware solution is included in the UE or implemented to mitigate the in-device interference. For example, the detecting and/or suspending may be initiated when the hardware solution is unsuccessful.

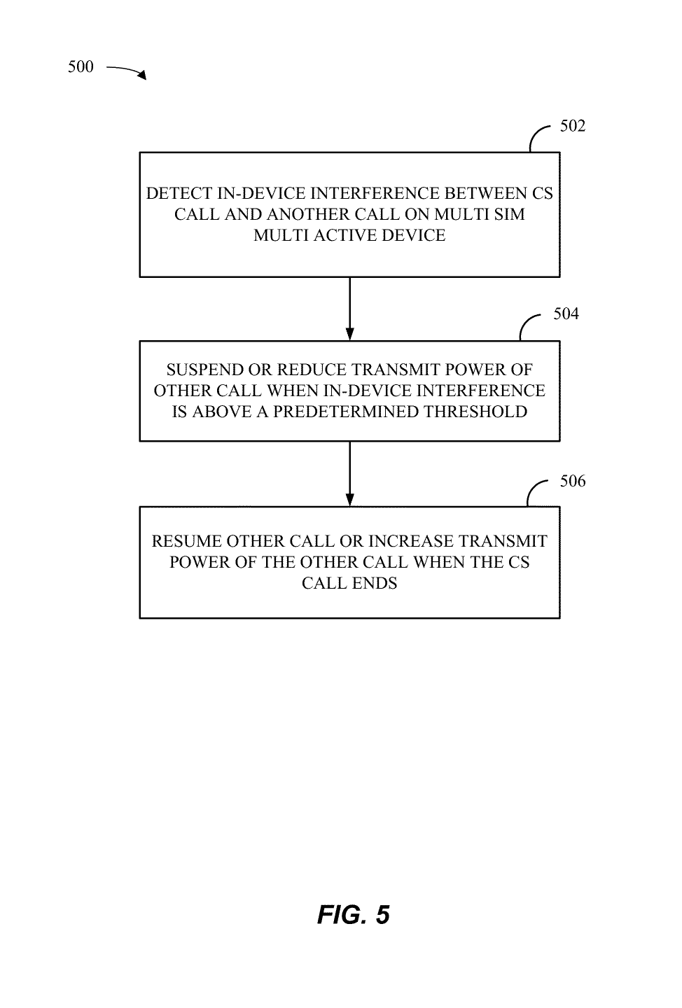

FIG. 5 shows a wireless communication method 600 according to one aspect of the disclosure. In this example, the UE detects in-device interference between a circuit switched call and another call in a multi subscriber identity module (SIM), multi active device, as shown in block 502. The UE suspends the other call or reduces a transmit power of the other call when the in-device interference is above a predetermined threshold, as shown in block 504. The UE resumes the other call or increases the transmit power of the other call when the circuit switched call ends, as shown in block 506.

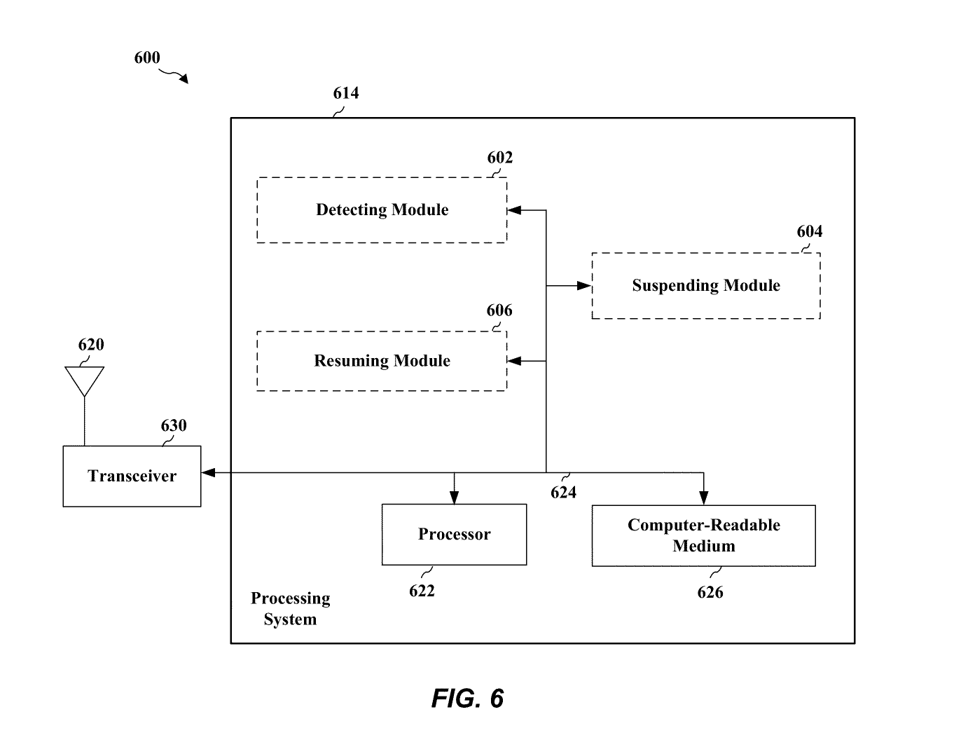

FIG. 6 is a diagram illustrating an example of a hardware implementation for an apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 622 the modules 602, 604, 606 and the non-transitory computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a transceiver 630. The transceiver 630 is coupled to one or more antennas 620. The transceiver 630 enables communicating with various other apparatus over a transmission medium. The processing system 614 includes a processor 622 coupled to a non-transitory computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 includes a detecting module 602 for detecting in-device interference between a circuit switched call and another call in a multi subscriber identity module (SIM), multi active device. The processing system 614 includes a suspending module 604 for suspending the other call or reducing a transmit power of the other call when the in-device interference is above a predetermined threshold. The processing system 614 includes a resuming module 606 for resuming the other call or increasing the transmit power of the other call when the circuit switched call ends. The modules may be software modules running in the processor 622, resident/stored in the computer-readable medium 626, one or more hardware modules coupled to the processor 622, or some combination thereof. The processing system 614 may be a component of the UE 350 and may include the memory 392, and/or the controller/processor 390.

In one configuration, an apparatus such as a UE is configured for wireless communication including means for detecting. In one aspect, the detecting means may be the antennas 352/620, the receiver 354, the channel processor 394, the receive frame processor 360, the receive processor 370, the transmitter 356, the transmit frame processor 382, the transmit processor 380, the controller/processor 390, the memory 392, interference mitigation module 391, the detecting module 608 and/or the processing system 614 configured to perform the aforementioned means. The UE is also configured to include means for suspending. In one aspect, the suspending means may be the channel processor 394, the receive frame processor 360, the receive processor 370, the transmit frame processor 382, the transmit processor 380, the controller/processor 390, the memory 392, interference mitigation module 391, the suspending module 604 and/or the processing system 614 configured to perform the aforementioned means. The UE is also configured to include means for resuming. In one aspect, the resuming means may be the channel processor 394, the receive frame processor 360, the receive processor 370, the transmit frame processor 382, the transmit processor 380, the controller/processor 390, the memory 392, interference mitigation module 391, the resuming module 606 and/or the processing system 614 configured to perform the aforementioned means. In one configuration, the means functions correspond to the aforementioned structures. In another aspect, the aforementioned means may be any module or any apparatus configured to perform the functions recited by the aforementioned means.

Several aspects of a telecommunications system have been presented with reference to LTE, TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
detecting in-device interference between a first circuit switched call and another call in a multi subscriber identity module, multi active device;
determining whether a hardware solution is implemented to mitigate the in-device interference;
suspending the other call or reducing a transmit power of the other call when the in-device interference is above a predetermined threshold when the implemented hardware solution is unsuccessful; and
resuming the other call or increasing the transmit power of the other call when the first circuit switched call ends.

2. The method of claim 1, in which the detecting is based at least in part on data throughput for the other call.

3. The method of claim 1, in which the detecting is based at least in part on a downlink error rate.

4. The method of claim 1, in which the detecting is based at least in part on uplink mobile transmission power.

5. The method of claim 1, in which the detecting is based at least in part on an expected de-sense pattern.

6. (canceled)

7. The method of claim 1, in which the other call is a second circuit switched call or a packet switched call.

8. An apparatus for wireless communication, comprising:
means for detecting in-device interference between a first circuit switched call and another call in a multi subscriber identity module, multi active device;
means for determining whether a hardware solution is implemented to mitigate the in-device interference;
means for suspending the other call or reducing a transmit power of the other call when the in-device interference is above a predetermined threshold when the implemented hardware solution is unsuccessful; and
means for resuming the other call or increasing the transmit power of the other call when the first circuit switched call ends.

9. The apparatus of claim 8, in which the detecting means comprises means for detecting based at least in part on data throughput for the other call.

10. The apparatus of claim 8, in which the detecting means comprises means for detecting based at least in part on a downlink error rate.

11. The apparatus of claim 8, in which the detecting means comprises means for detecting based at least in part on uplink mobile transmission power.

12. The apparatus of claim 8, in which the detecting means comprises means for detecting based at least in part on an expected de-sense pattern.

13. (canceled)

14. The apparatus of claim 8, in which the other call is a second circuit switched call or a packet switched call.

15. An apparatus for wireless communication, comprising:
a memory; and
at least one processor coupled to the memory and configured:
to detect in-device interference between a first circuit switched call and another call in a multi subscriber identity module, multi active device;
to determine whether a hardware solution is implemented to mitigate the in-device interference;
to suspend the other call or reduce a transmit power of the other call when the in-device interference is above a predetermined threshold when the implemented hardware solution is unsuccessful; and
to resume the other call or increase the transmit power of the other call when the first circuit switched call ends.

16. The apparatus of claim 15, in which the at least one processor is further configured to detect based at least in part on data throughput for the other call.

17. The apparatus of claim 15, in which the at least one processor is further configured to detect based at least in part on a downlink error rate.

18. The apparatus of claim 15, in which the at least one processor is further configured to detect based at least in part on uplink mobile transmission power.

19. The apparatus of claim 15, in which the at least one processor is further configured to detect based at least in part on an expected de-sense pattern.

20. (canceled)

21. The apparatus of claim 15, in which the other call is a second circuit switched call or a packet switched call.

22. A computer program product for wireless communication, comprising:
a non-transitory computer-readable medium having program code recorded thereon, the program code comprising:
program code to detect in-device interference between a first circuit switched call and another call in a multi subscriber identity module, multi active device;
program code to determine whether a hardware solution is implemented to mitigate the in-device interference;
program code to suspend the other call or reduce a transmit power of the other call when the in-device interference is above a predetermined threshold when the implemented hardware solution is unsuccessful; and
program code to resume the other call or increase the transmit power of the other call when the first circuit switched call ends.

23. The computer program product of claim 22, in which the computer program product further comprises program code to detect based at least in part on data throughput for the other call.

24. The computer program product of claim 22, in which the computer program product further comprises program code to detect based at least in part on a downlink error rate.

25. The computer program product of claim 22, in which the computer program product further comprises program code to detect based at least in part on uplink mobile transmission power.

26. The computer program product of claim 22, in which the computer program product further comprises program code to detect based at least in part on an expected de-sense pattern.

27. (canceled)

28. The computer program product of claim 22, in which the other call is a second circuit switched call or a packet switched call.
